(19) United States
(12) Patent Application Publication
(10) Pub. No.: US 2009/0320192 A1
(43) Pub. Date: Dec. 31, 2009

(54) Fire-resistant cooling suit

(76) Inventor: Barbara Hildegard Pause, Longmont, CO (US)

Correspondence Address: Barbara Pause, 7161 Christopher Court, Longmont, CO, 80503, US

(21) Appl. No.: 11/919,412

(22) PCT Filed: May 4, 2006
(86) PCT No.: PCT/US06/17280

§ 371 Date: Oct. 25, 2007

Related U.S. Application Data
(60) Provisional application No. 60/680,741, filed on May 12, 2005.

(51) Int. Cl. A62B 17/00

(52) U.S. Cl. 2/458

(57) ABSTRACT

Cooling undergarment consisting of a composite of two fabrics arranged adjacent to an elastomeric material having finely divided phase change material such as non-combustible salt hydrates dispersed wherein facilitate a cooling effect due to latent heat absorption in the phase transition range of the phase change material, which improves the thermal performance and enhances the comfort of protective garment systems worn in conjunction with it.

### CROSS-REFERENCES TO RELATED APPLICATIONS

This application claims priority of U.S. provisional application Ser. No. 60/680,741 filed May 12, 2005 entitled “Fire-resistant cooling suit”. The international application Serial No. PCT/US2006/017280 entitled “Fire-resistant cooling suit” was filed May 4, 2006 and published Nov. 23, 2006.

### BACKGROUND OF THE INVENTION

Most protective garment systems possess a poor thermo-physiological wearing comfort due to the insufficient transfer of heat and moisture through the layers the garment consists of. As a result, under strenuous activities and moderate to hot climatic conditions, the core temperature of the wearer's body may rise above the comfort level into the heat stress zone. These heat stress conditions lead to discomfort and fatigue and, in severe cases, risk the health and safety of the garment's wearer. The constant discomfort while wearing such protective garment systems can lead to a reduced productivity and an increased likelihood of accidents.

A very expensive solution of the problem nowadays is the use of a bulky and heavy microclimate cooling system. However, a much cheaper and durable solution would be the application of phase change material—a highly productive thermal storage mean.

Phase change material possesses the ability to change its physical state within a certain temperature range. When the melting temperature is obtained during a heating process, the phase change from the solid to the liquid state occurs. During this melting process, the phase change material absorbs and stores a large amount of latent heat. In a cooling process of the phase change material, the stored heat is released into the environment in a certain temperature range; and a reverse phase change from the liquid to the solid state takes place.

During the entire melting process, the temperature of the phase change material as well as its surrounding area remains constant. The undesired temperature increase, concomitant during the normal heating process, does not occur. The same is true for the crystallization process. During the entire crystallization process, the temperature of the phase change material also does not change. The high heat transfer during the melting process and the crystallization process, both without any temperature change, is responsible for the phase change material's appeal as a source of heat storage.

In order to contrast the amount of latent heat absorbed by a phase change material during the actual phase change with the amount of sensible heat in an ordinary heating process, the ice-water phase change process will be used for comparison. When ice melts, it absorbs an amount of latent heat of about 335 J/g. When the water is further heated, it absorbs a sensible heat of only 4 J/g while its temperature rises by one degree C. Therefore, the latent heat absorption during the phase change from ice into water is nearly 100 times higher than the sensible heat absorption during the heating process of water outside the phase change temperature range.

In addition to ice (water), more than 500 natural and synthetic phase change materials are known. These materials differ from one another in their phase change temperature ranges and their heat storage capacities. The phase change materials used in textile applications are crystalline alkyl hydrocarbons summarized in Table 1.

TABLE 1
Thermal characteristics of selected crystalline alkyl hydrocarbons

| | Melting | Crystallization | Heat storage |
|---|---|---|---|
| Alkyl | temperature | temperature | capacity |
| hydrocarbons | in ° C. | in ° C. | in J/g |
| Hexadecane | 18.5 | 16.2 | 237 |
| Heptadecane | 22.5 | 21.5 | 213 |
| Octadecane | 28.2 | 25.4 | 244 |
| Nonadecane | 32.1 | 26.4 | 222 |
| Eicosane | 36.1 | 30.6 | 247 |

The crystalline alkyl hydrocarbons are either used in technical grades with a purity of approximately 95%; or they are blended with one another in order to cover specific phase change temperature ranges. The crystalline alkyl hydrocarbons are nontoxic, non-corrosive, and non-hygroscopic. The thermal behavior of these phase change materials remains stable under permanent use. Crystalline alkyl hydrocarbons are byproducts of petroleum refining and, therefore, inexpensive. A disadvantage of crystalline alkyl hydrocarbons is their low resistance against ignition.

Salt hydrates are alloys of inorganic salts and water. The most attractive properties of salt hydrates are the comparatively high latent heat storage capacities, the high thermal conductivities and the small volume change during melting. They are mostly non-combustible which makes them specifically attractive for garment applications where the garment needs to possess fire-resistance properties. Salt hydrates often show an incongruent melting behavior as a result of a lack in reversible melting and freezing making them unsuitable for permanent use. Salt hydrates with reversible melting and freezing characteristics are summarized in Table 2.

TABLE 2
Thermal characteristics of selected salt hydrates

| | Melting | Latent heat storage |
|---|---|---|
| Salt hydrates | temperature, ° C. | capacity, J/g |
| Calcium Cloride Hexahydrate | 29.4 | 170 |
| Lithium Nitrate Trihydrate | 29.9 | 236 |
| Sodium Sulfate Decahydrate | 32.4 | 253 |

In the present applications of the phase change material technology in textiles, the crystalline alkyl hydrocarbon are microencapsulated, i.e., contained in small micro-spheres with diameters between 1 micron and 30 microns. These microcapsules with enclosed phase change material are applied to a textile matrix by incorporating them into acrylic fibers and polyurethane foams or by embedding them into a coating compound and coating them onto textile surfaces.

U.S. Pat. No. 4,756,958 reports a fiber with integral micro-spheres filled with phase change material which has enhanced thermal properties at predetermined temperatures.

U.S. Pat. No. 5,366,801 describes a coating where micro-spheres filled with phase change material are incorporated into a coating compound which is then topically applied to fabric in order to enhance the thermal characteristics thereof.

U.S. Pat. No. 5,637,389 reports an insulating foam with improved thermal performance, wherein micro-spheres filled with phase change material are embedded.

The micro-encapsulation process of crystalline alkyl hydrocarbon phase change materials is a very time-consuming and complicated chemical process running over several stages making the microcapsules with enclosed phase change material very expensive. Using phase change materials in fabric systems, the following thermal benefits are obtained:
A cooling effect, caused by heat absorption of the phase change material.
A heating effect, caused by heat emission of the phase change material.
A thermo-regulating effect, resulting from either heat absorption or heat emission of the phase change material.

The efficiency of each of these effects is determined by the thermal capacity of the phase change material, the phase change temperature range and the structure of the carrier system.

The total thermal capacity of the phase change material in a certain product depends on the phase change materials specific thermal capacity and its quantity. The necessary quantity of the phase change material can be estimated through the consideration of application conditions, such as the requested duration of the application and the thermal capacity of the specific phase change material. In order to obtain a successful phase change material application, the phase change temperature range and the application temperature range need to correspond.

In addition, performance tests carried out on textiles with phase change material have shown that the textile substrate construction also influences the efficiency of the thermal effects obtained by the phase change material. For instance, thinner textiles with higher densities readily support the cooling process. In contrast, the use of thicker and less dense textile structures leads to a delayed and therefore more efficient heat release of the phase change material.

In the cooling suit application, the main function of the phase change material will be the absorption of excessive heat generated by the body while performing strenuous activities in warm climatic conditions. The heat absorption by the phase change material will keep the microclimate temperature in the comfort range over an extended period of time preventing a higher amount of sweat from being produced by the skin.

### SUMMARY OF THE INVENTION

The invention pertains to a cooling undergarment which is worn in conjunction with a protective garment system. The cooling undergarment is made of patches of an elastomeric material comprising finely-divided phase change material, which are quilted between two fabric layers. The phase change material consists of a non-combustible salt hydrate in order to meet fire-resistance requirements. The fabrics are made of fire-resistant fibers. Preferably, the patches made of an elastomeric compound material are located in the upper chest, the upper arm and the thigh area. Due to the latent heat absorption feature of the phase change material, excess body heat of the wearer is absorbed during strenuous activities leading to a significant improvement of the thermo-physiological wearing comfort of protective garment systems.

### BRIEF DESCRIPTION OF THE DRAWINGS

FIG. 1 is a sectional view of a cooling undergarment consisting of patches of an elastomeric material wherein phase change material is incorporated and the patches are arranged between two fabric layers.

FIG. 2 is a front and a rear view of a cooling suit design.

FIG. 3 is a graphical representation of the temperature development in the microclimate while wearing a chemical protective garment in conjunction with undergarments with and without phase change material.

FIG. 4 is a graphical representation of the moisture development in the microclimate while wearing a chemical protective garment in conjunction with undergarments with and without phase change material.

### DETAILED DESCRIPTION OF THE INVENTION

It has been discovered that crystalline alkyl hydrocarbons and salt hydrates can be durably contained in an elastomer whereby the phase change materials are cross-linked into the elastomer's structure. For this purpose, the phase change material does not need to be microencapsulated. Finely-divided phase change materials emulsified or dispersed in the elastomer's structure do not flow out of the elastomer structure while in a liquid stage. The composition remains stable under substantial temperature variation over a long service time.

Such elastomeric materials can comprise, by way of example and not by limitation silicone rubber, acrylate rubber, butyl rubber, nitrite rubber or chloroprene rubber.

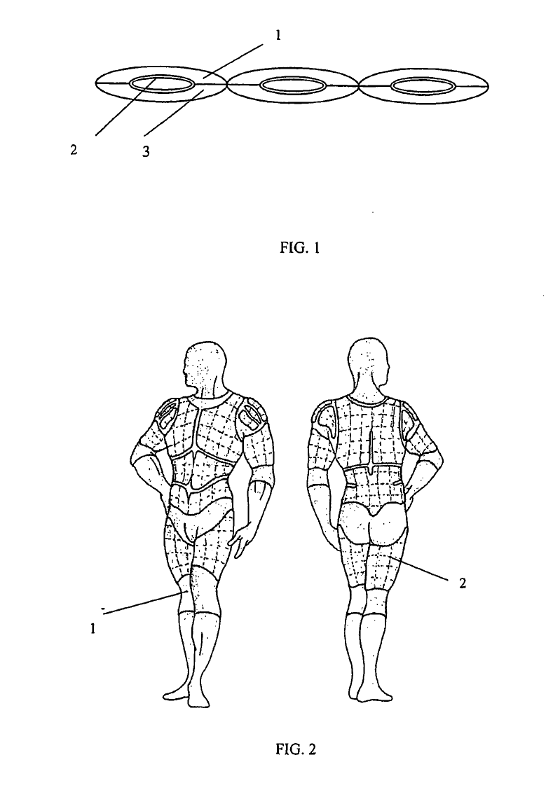

Preferably, the elastomeric materials with incorporated phase change material are formed into patches. These patches (2) are quilted between an inner fabric (1) and an outer fabric (3). Preferably, the fabrics are made of fire-resistant fibers such as Nomex or Kevlar fibers. Preferable, the fabrics are lightweight, mechanically stable and provide a sufficient heat and moisture management. FIG. 1 shows a suitable construction of the cooling under garment.

In a preferred embodiment of the present invention, the patches (2) do not cover the whole suit. They are arranged in the areas where the most heat is provided by the human body—the upper chest area, the upper arm area and the thighs. FIG. 2 shows the front and the rear side of a possible cooling suit design.

Most preferably, the phase change material used in the cooling undergarment consists of a non-combustible salt hydrate in order to meet fire-resistance requirements. Such salt hydrates can comprise, by way of example and not by limitation, calcium cloride hexahydrate, lithium nitrate trihydrate, or sodium sulfate decahydrate.

Due to the use of the cooling suit as an undergarment of protective garment systems, the phase change material should start to absorb latent heat as soon as the microclimate temperature increases above the comfort range. In order to meet this requirement, the selected phase change material absorbs latent heat preferably in a temperature range between 32° C. and 36° C. The latent heat absorbed by the phase change material is released under room temperatures below 25° C.

The cooling suit is worn in conjunction with protective garment systems used by fire fighters, steel mill workers, workers in chemical and nuclear facilities, and by police and military personnel. In order to meet thermal performance requirements resulting from various activities and wearing times, a latent heat storage capacity was determined which is sufficient for a larger range of applications. The necessary latent heat storage of the cooling suit totals about 100 kJ.

In order to determine the improvement in thermo-physiological wearing comfort resulting from the phase change material application in the cooling undergarment, controlled wearer trials have been performed. The wearer trials have been carried out in a climatic chamber under an ambient temperature of 21° C. and a relative humidity of 40%. The tests were performed by riding a bicycle-ergometer over a period of 60 minutes without interruption.

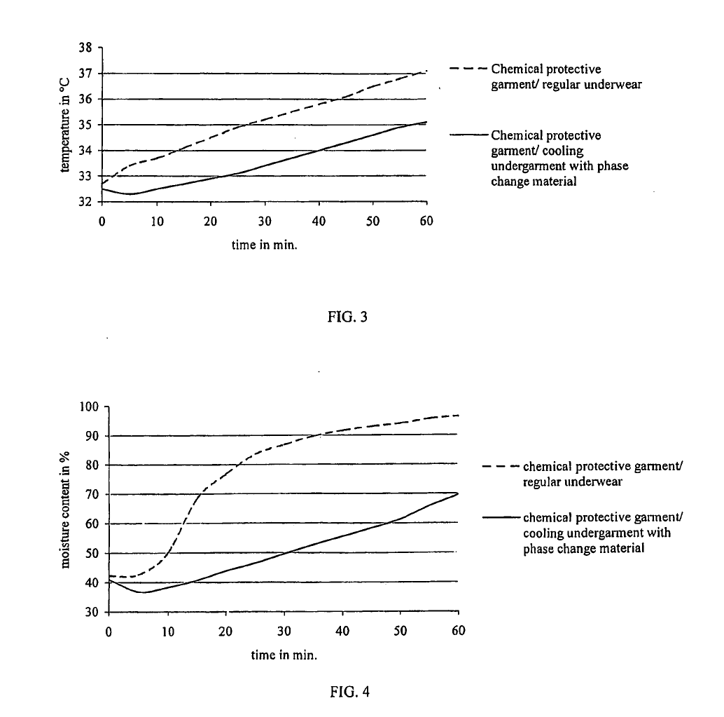

During the test, the test subjects wore a chemical protective suit with either the cooling undergarment or a regular underwear. While carrying out the described activity, a metabolic heat rate of about 18 kJ/min. is generated by the body. A dry heat transfer in the amount of 16 kJ/min. is released through the protective garment system. During the test, skin temperatures and moisture contents in the microclimate were recorded at several measuring points. The mean skin temperature and the average moisture content were calculated from the measurements. FIG. 3 shows the development of the mean skin temperature during the test.

The test results shown in FIG. 3 indicate that there is a fast increase in the mean skin temperature when wearing the chemical protective suit with regular underwear. After 45 minutes, the mean skin temperature already exceeds 36° C. At this point, a heat stress situation is likely. On the other side, the cooling effect by heat absorption of the phase change material leads to a substantial delay in the temperature increase while wearing the chemical protective garment with the cooling undergarment underneath it under the same conditions. At the end of the test, the difference in the mean skin temperature totals 2° C. The delay in the temperature decrease results in a significantly smaller amount of moisture build up in the microclimate such as it is shown in FIG. 4.

While wearing an air-tight chemical protective overall, the moisture content in the microclimate underneath the suit rises substantially due to the lack in moisture transfer through the material the suit consists of. Already after 15 minutes, the moisture content in the microclimate leads to a feeling of an uncomfortable dampness. In contrast, the delayed increase in the mean skin temperature by the heat absorption of the phase change material results in a substantially lower amount of moisture generated by the skin. Therefore, the moisture content of the microclimate is kept on a much lower level throughout the test. Thus, wearing the cooling suit with phase change material underneath the air-tight chemical protective garment leads to a significant increase in the protective system's thermo-physiological wearing comfort.

The test results further indicate that wearing the chemical protective suit without the cooling undergarment over a period of more than 45 minutes under the given activity level and the prevailing climatic conditions, the mean skin temperature rises above a level where heat stress is very likely. Additional tests have shown that the cooling effect provided by the phase change material leads substantially longer wearing times. For instance, under the described test conditions the wearing time could be doubled without a health risk. The longer wearing times without heat stress risks will result in a significantly higher productivity.

Preferred embodiments of the present invention have been described with a degree of particularity. It should be understood that this description has been made by way of preferred example, and that the invention is defined by the scope of the claims.

What is claimed::

1. An cooling undergarment article, consisting of:
a first layer comprising a fabric;
a second layer comprising an elastomeric compound having finely-divided phase change material dispersed therein;
a third layer comprising a fabric;
and that said article has enhanced reversible thermal properties.

2. An article according to claim 1, wherein the elastomeric compound with the incorporated phase change material is formed into discrete patches which are quilted between the fabrics creating the first and the third layer of said arrangement.

3. An article according to claim 1, wherein the patches forming the second layer are arranged in the upper chest area, the upper arm area and the thighs area of the suit.

4. An article according to claim 1, wherein the first layer and the third layer made of fabrics consisting of fire-resistant fibers.

5. An article according to claim 1, wherein the phase change material is a noncombustible salt hydrate.

6. An article according to claim 1, wherein the phase change material have melting points in the range between 30° C. and 40° C.

7. An article according to claim 1, possessing a latent heat storage capacity of at least 100 kJ.
